(19) United States
(12) Patent Application Publication
(10) Pub. No.: US 2011/0191692 A1
(43) Pub. Date: Aug. 4, 2011

(54) SYSTEM AND METHOD FOR E-BOOK CONTEXTUAL COMMUNICATION

(75) Inventors: Richard J. Walsh, Raleigh, NC (US); Benjamin Ferid Issa, Apex, NC (US)

(73) Assignee: OTO TECHNOLOGIES, LLC, Raleigh, NC (US)

(21) Appl. No.: 12/699,123

(22) Filed: Feb. 3, 2010

(51) Int. Cl. G06F 3/00

(52) U.S. Cl. 715/752

(57) ABSTRACT

A computerized system and method for providing a service that processes a user's edit and reading events to determine one or more electronic book, or e-book, contexts for the user is disclosed. In particular, the service calculates a contextual affinity the user has with other users based on e-book contexts for the e-book contexts. The service may automatically establish voice and/or text communication sessions for users identified as having a significant degree of affinity with the user. Once a communication session is established, a user can conveniently collaborate with other users for which commonly determined contexts are relevant. Moreover, the present disclosure also describes how a user can modify incoming text, voice, and notification messages to have an individualized presentation to other users based upon the degree of contextual affinity between various users.

### FIELD OF THE DISCLOSURE

The present disclosure relates to providing contextual communication for e-content such as electronic books, or e-books. In particular, the present disclosure provides electronic reader, or e-reader, device users with a way to conveniently communicate with other e-reader device users that are matched based upon relevant contexts identified from e-content being read, developed, or edited by the e-reader device users.

### BACKGROUND

Reading sessions involving e-content such as electronic books, or e-books, have grown in popularity, and the electronic nature of the e-book experience presents new opportunities and challenges as the frontier of e-book technology advances. Many of the new opportunities and challenges pertain to enhancing experiences involving various e-book communities, such as e-book content developers and collaborators.

An e-book is an electronic version of a traditional print book that can be read by using an electronic reader, or e-reader, device. E-reader functionality for reading e-books is in part provided by an e-reader device having a display for displaying text and graphics and a control input for receiving user input to manipulate e-book pages. Some modern e-reader devices include a touch screen display that is useable as both a control input and a display.

E-reader functionality may be provided on a dedicated e-reader device such as an Amazon.com Kindle™ or a Barnes and Noble Nook™ or provided as an additional function of a communication device, such as a mobile telephone, a personal digital assistant, a personal computer, or the like. Any device that provides e-reader functionality is rendered an e-reader device. A present example of a mobile telephone device that may be rendered as an e-reader device is the iPhone smart phone, which is manufactured by Apple, Inc. of Cupertino, Calif. For example, an e-reader software application running on the iPhone renders the iPhone an e-reader device. A presently available e-reader software application is Stanza provided by Lexcycle LLC, which is presently owned by Amazon.com.

In operation, e-book content is downloaded to the e-reader device and then displayed as text and/or graphics, generally on a page by page basis. For example, e-reader devices provide user interfaces that are used to virtually turn pages and provide input for searching and requesting particular e-book content. Once a page is read, a user can instruct the e-reader device to present the next page, and so on and so forth. In response to a search query, content or pages responsive to the query are presented. Moreover, an e-reader device typically has wireless connectivity for downloading content and conducting other Web-based tasks such as browsing the Internet and receiving email.

One problem facing users of e-reader devices that need to communicate or collaborate regarding e-books is that the users generally default to broadcasting their text and voice conversations to all collaborators, who are then distracted in order to differentiate which text and voice messages are relevant to their tasks or expertise. Another problem is that e-reader device users generally need to consciously determine who among other collaborators they should communicate with regarding edits or questions. Moreover, a collaborating e-reader device user may miss important notifications regarding document changes that are relevant to them, or may spend large amounts of time reviewing lists of changes of unknown relevance during or after a collaboration session. Thus, a need exists for systems and methods that address these needs by providing users of e-reader devices with ways to communicate and collaborate with other users of e-reader devices regarding e-book content having contexts that are within the individual scope of each e-reader user's interest, task, and/or expertise.

### SUMMARY

The present disclosure addresses the need to communicate or collaborate on electronic books, or e-books, by providing electronic reader, or e-reader, device users with an e-book context service that includes a contextual analysis function, an e-book library, and a communication function. In general, the e-book context service is a computerized method for e-book contextual communication. The computerized method begins by receiving information that is associated with an e-reader device user event. The process continues by identifying relevant e-reader device users, which are relevant to the e-reader device user event based upon a context included in the information or determined from the information, as relevant e-reader device users, and then effecting communication between the relevant e-reader device users.

Those skilled in the art will appreciate the scope of the present invention and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the invention, and together with the description serve to explain the principles of the invention.

FIG. 1 is a block diagram representing one embodiment of the present system.

FIG. 2A is a flow diagram illustrating a process and communication flow according to the present method.

FIG. 2B is a flow diagram illustrating an additional communication flow according to the present method.

FIG. 3 is an ontology graph representing an example context overlap.

FIG. 4 is an example of a user interface that identifies the current context of the electronic reader, or e-reader, device user.

FIG. 5 depicts an e-reader device with output that provides a sense of a contextual community by adapting messages from other users based on contextual affinity.

FIG. 6 depicts a use case illustrating a contextual relevance between e-reader device users.

FIG. 7 depicts a context service of the present system being implemented as a network cloud service.

FIG. 8 depicts a block diagram of a wireless smart phone that can be used as an e-reader device according to embodiments of the present disclosure.

### DETAILED DESCRIPTION OF THE PREFERRED EMBODIMENTS

The embodiments set forth below represent the necessary information to enable those skilled in the art to practice the invention and illustrate the best mode of practicing the invention. Upon reading the following description in light of the accompanying drawing figures, those skilled in the art will understand the concepts of the invention and will recognize applications of these concepts not particularly addressed herein. It should be understood that these concepts and applications fall within the scope of the disclosure and the accompanying claims.

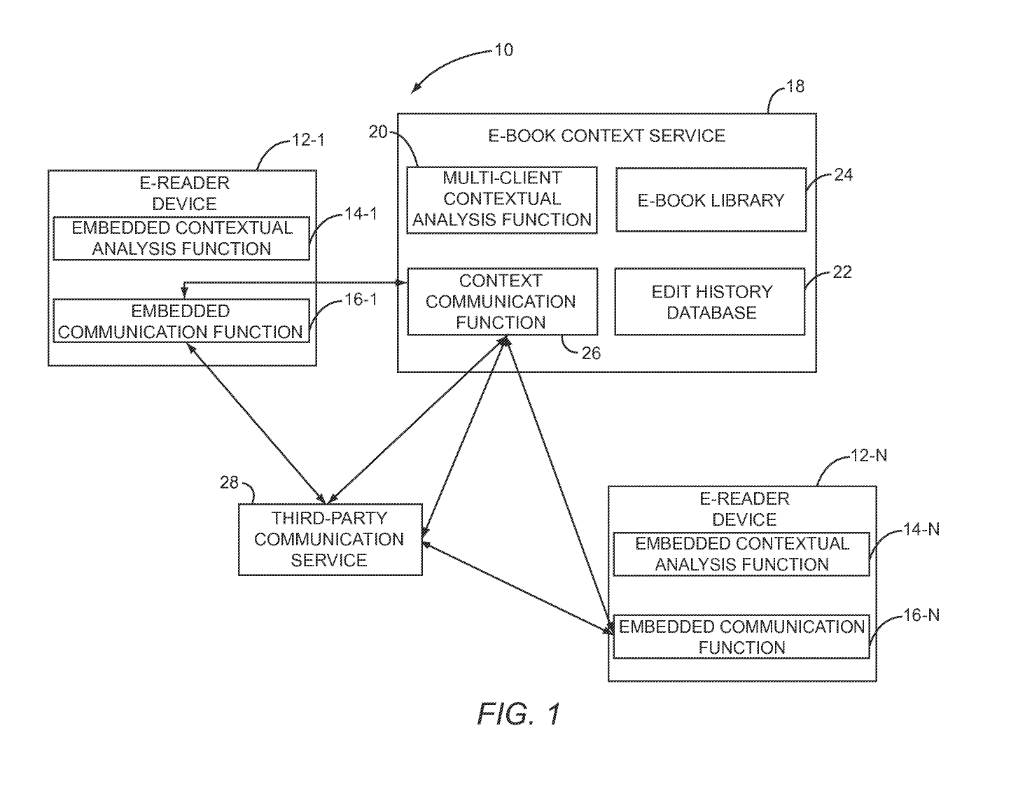

FIG. 1 depicts a system 10 according to the present disclosure. The system 10 includes electronic reader, or e-reader, devices 12-1 through 12-N, where N is a positive integer. Each of the e-reader devices 12-1 through 12-N have an embedded contextual analysis function 14-1 through 14-N and an embedded communication function 16-1 through 16-N. The system 10 also has an electronic book, or e-book, context service 18 that includes a multi-client contextual analysis function 20 as well as an edit history database 22 that is useable with the multi-client contextual analysis function 20 to identify e-reader device users that share common contexts.

The e-book context service 18 has an associated e-book library 24 to provide users with e-book content for the users' e-reader devices 12-1 through 12-N. The e-book library 24 also provides content to the multi-client contextual analysis function 20 to avoid having to pull heavy bandwidth consuming content from the e-reader devices 12-1 through 12-N during a context analysis. The e-book context service 18 also includes a context communication function 26 that may communicate directly with the e-reader devices 12-1 through 12-N via a wireless personal area network (WPAN) or local area network (LAN) in an office or classroom environment. Alternately, the e-book context service 18 may use the context communication function 26 to coordinate with a third-party communication service 28 that is usable to facilitate text, text chat, voice, short message service (SMS), and other forms of electronic communication between the e-reader devices 12-1 through 12-N. Note that the context communication function 26 operates to enable communication on a wired or wireless network. An example of a wired network is an Ethernet based local area network. Examples of wireless networks are a Wireless Fidelity (WiFi) network or a cellular network such as a third generation (3G) wireless network.

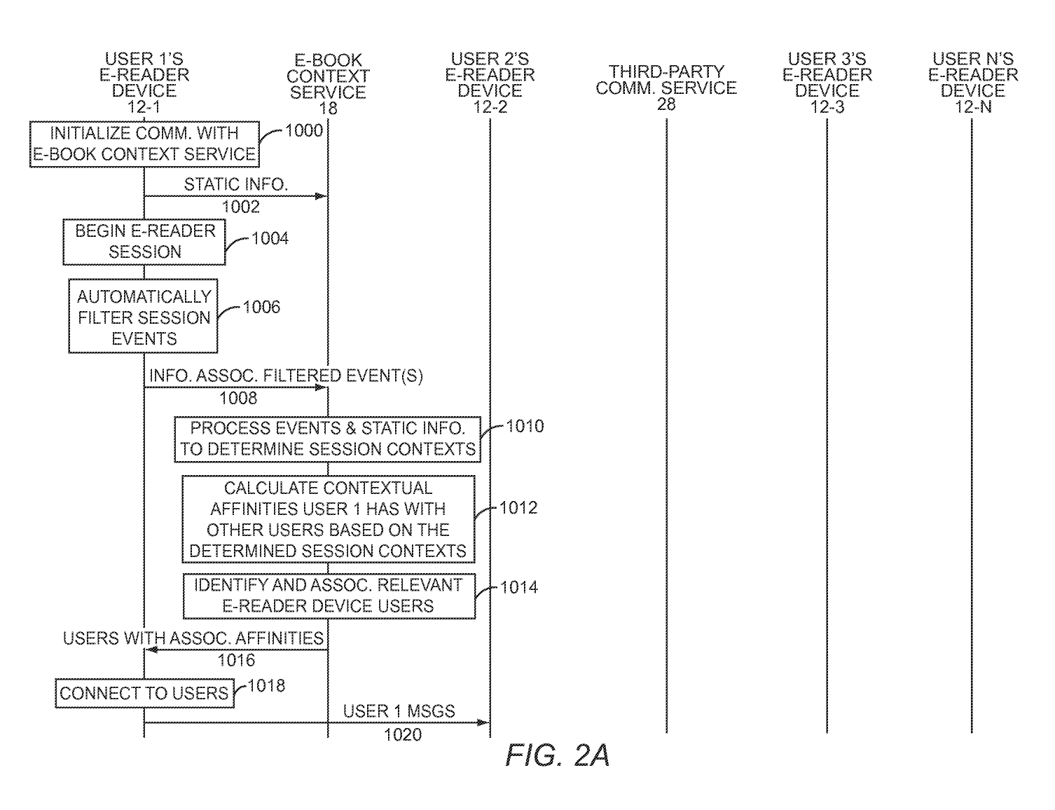

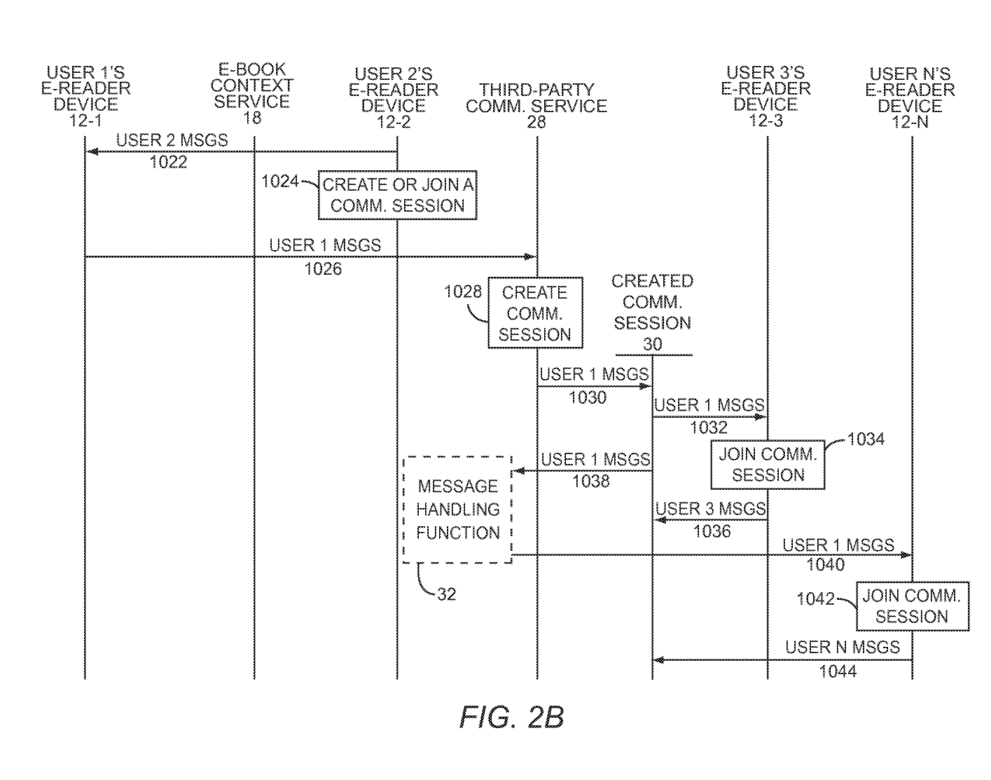

FIG. 2A is a sequence diagram showing the e-reader device 12-1 coordinating with the e-book context service 18 in order to communicate with other contextually relevant e-reader device users. First, the e-reader device 12-1 initializes a communication session with the e-book context service 18 for subsequent communication (step 1000). The initialization of the communication session may involve a login process for the e-reader device user to provide credentials for authentication. It is also preferred that static information, such as e-reader device information that includes make, model, and capabilities of the e-reader device 12-1, be sent once to the e-book context service 18 during a session initialization to avoid sending the same data repeatedly (step 1002). During the communication session initialization, additional information pertaining to the e-reader device context may also be sent to the e-book context service 18. The additional e-reader device information may include, but is not limited to, the physical location of the e-reader device 12-1 and the type of connectivity including current bandwidth, etc. Note that the contextual information of the e-reader devices 12-1 through 12-N may be dynamic. Therefore, the e-reader device 12-1 may be adapted to periodically update the e-book context service 18. Further still, the e-reader devices 12-1 through 12-N may be adapted to automatically trigger an update to the e-book context service 18 upon a detection of a significant change pertaining to an e-reader device context. For example, a significant change in e-reader device context may be a physical movement of the e-reader device 12-1 to outside of a predefined area. Another significant change would be a change in connectivity from WiFi to 3G, etc. Moreover, e-reader device user information such as user name, demographics, and social network information could also be sent during communication initialization. The social network information may include identifiers that are associated with friends and groups having particular interests such as hobbies, etc.

At or about the same time, the user of e-reader device 12-1 will begin an e-reader session (step 1004). For the purpose of this disclosure, a session event is synonymous with an e-reader device user event. As the user of the e-reader device 12-1 proceeds with an e-reader user activity such as editing or reading an e-book, the user's e-reader device 12-1 automatically determines which e-reader device user events are contextually relevant and filters out contextually irrelevant events such as typographical error corrections (step 1006). However, it is important to note that in a teaching environment such as an English class, it may be desirable to pass typographical errors to the e-book context service 18. As a result, the e-reader device 12-1 may be provisioned with filtering rules that may include built-in default filtering rules that are provided from another entity such as a teacher, author, publisher, or by the e-book context service 18. The filtering rules may be customized based upon genre and popularity, etc. Moreover, the e-reader device user events may be batch processed or individually processed periodically. Moreover, a filter rule may only be relevant to specific sections of an e-book. For example, a filter rule may be configured to filter out e-reader device user events pertaining to a forward section or index section of a book. Further still, a filter rule may be based on a period of time within an e-reader session. For example, a filter rule may be configured such that e-reader device event processing and filtering do not occur until a given time after an e-reader session is started. Examples of significant e-reader device user events include, but are not limited to, a date change, a page turn, a page scroll, a content deletion, and/or a content addition. It is also preferable for any determinations of context made by the embedded e-reader contextual analysis function 14-1 be sent via the embedded communication function 16-1 to the e-book context service 18 (step 1008). It should be understood that the multi-client contextual analysis function 20 of the e-book context service 18 performs the same general context analysis function performed by the embedded e-reader contextual analysis function 14-1.

In case the e-reader device 12-1 does not include the embedded contextual analysis function 14-1, the e-reader device 12-1 will forward event data pertaining to the user's edits and/or current reading session to the e-book context service 18, which in turn will perform a context analysis on the forwarded event data via the multi-client contextual analysis function 20. Moreover, the e-reader devices 12-1 through 12-N may be provisioned dynamically with the necessary data to support the embedded context analysis functions 14-1 through 14-N to analyze a user's current e-book, a particular section of an e-book, and/or all the e-books stored on the e-reader devices 12-1 through 12-N, etc. Further still, triggers may be established for the dynamic provisioning of data needed to analyze a user's current e-book. One such trigger may be based upon a time such that the dynamic data provisioning is performed periodically, such as every day. Another trigger may be based on a reading session change as the user's progress into or proximity to a new page or chapter of the user's e-book. Yet another trigger for the dynamic provisioning of data needed to analyze a user's current e-book may be user invoked with other criteria, such as receiving a new publication of the current e-book.

The contextual information associated with the e-reader device user events may also accompany additional event information such as an International Standard Book Number (ISBN) for the current e-book along with an e-book reading location that may include, but is not limited to, a page number, a section, a paragraph, a sentence, a phrase, a word, a figure, and a table. Other information such as device location information, such as Global Positioning System (GPS) coordinates and/or postal zip code, may also be sent to the e-book context service 18. Moreover, e-reader device user information including, but not limited to, user id, profile, and information obtained from, or associated with social network services may also be included in the information sent to the e-book context service 18. Information about a content change type such as a content edit, a content removal, a content addition, and a content modification along with the e-reader device time and date may also be sent to the e-book context service 18.

Next, the e-book context service 18 processes the static information along with the information associated with the e-reader device user event(s) along with predetermined context information to determine a context for the user of the e-reader device 12-1 (step 1010). The multi-client contextual analysis function 20 executes a configurable set of context rules that are useable to determine one or more contexts for an e-reader device user event while an e-reader device user is editing or reading an e-book. The context rules may be provided by author, publisher, e-book context service provider, and/or a community of users. In one case, a context rule might be specific to an e-book. For example, a context rule associated with the book Moby Dick tests the user's current edit location to a particular section in which the character Starbuck dies. If the context rule is successful, the user's context is “Starbuck,” “death,” “action,” “tragedy,” “drown,” “ocean,” and “kelp.” In another case, a rule may be agnostic to the e-book. For example, a context rule may process event data to determine the relative edit location of a user in a chapter such as “beginning,” “middle,” “close to the end,” and so forth. A context rule may examine a set of events such that the context rule can describe the user's current behavior. For example, a context rule might examine the last ten events from a user to set the user's context to events such as “removing content about dogs,” “modifying content about cats,” etc. Generally, a context is determined with respect to a current e-book or variations of an e-book, such as an e-book having different editions. However, a context may be applicable across a common set of contents such as an e-book series. Examples of e-book series can be, but are not limited to, the Lord of the Rings Trilogy, a detective series, an author series, a genre series, etc.

Moreover, the e-book context service 18 may load a set of context rules when a user of an e-reader device 12-1 begins an e-reader session, and cache the set of context rules for subsequent use. Alternately, the e-book context service 18 may load the set of context rules on demand. The e-book context service 18 preferably allows a user of an e-reader device 12-1 such as a teacher, a service operator, and the like to dynamically specify which of the set of context rules are applicable based upon the user of the e-reader device 12-1, the model or version of the e-reader device 12-1, e-book subscription information, e-book metadata, and physical location of the e-reader device 12-1.

The e-book context service 18 may be adapted to recommend context rules based on an e-book, an e-book device user's social network information, a particular context rule's popularity, a particular context rule's usage rates, a particular context rule's user reviews, and so forth. Another possible option is that context rules include criteria that may be evaluated in order to determine whether the context rules are applicable. For example, a context rule may test a reading session's e-book ISBN information or other such data to determine that the context rule is appropriate for the current user event data. In addition, a context rule may determine a type of e-reader device user edit by comparing a previous version of content with an edited version of the content. An example of the types of edits that may be determined in this fashion includes, but is not limited to, a content removal, a spelling correction, a content replacement, and/or a change in verb tense.

The context rules can be written in a specialized or general purpose programming language such as Java, C, JavaScript, Python, and so forth. Context rules are provided with application programming interfaces (APIs) to access to a user's e-reader session information, e-reader user events, e-book content, semantic analysis functions, natural language functions, social network service functions, e-book library functions, temporary or permanent storage functions, location based functions, and other such functions that enable the context rule to determine one or more contexts. In addition, a context rule may be provided access to information associated with other e-reader sessions of other e-reader devices that are determined to be in proximity based on location, social network relationships, same or related e-book, and so forth. For example, a context rule may access given e-reader session data for users of e-reader devices enrolled in a particular class subject. A context rule may produce intermediate or final results that it may cache or store for subsequent use for the same, all, or a set of other users. For example, a context rule may temporarily store a set of users that are at a particular physical location so as not to have to re-calculate the operation repeatedly. The particular physical location may be determined by GPS coordinates associated with the e-reader devices 12-1 through 12-N.

As another option, the e-book context service 18 may have a larger, different, or newer set of context rules to process the information associated with the e-reader device user events. As a result, the e-book context service 18 may associate additional contexts to the event and/or remove contexts that are no longer valid. In addition to the context rules, the e-book context service 18 can perform a semantic analysis on an e-book's content to identify contexts that are applicable for the e-book.

As another option, the e-book context service 18 can predictively associate a user with a set of other users based on historical information and consumption metrics. For example, the e-book context service 18 determines that a user will soon complete reading a page and the next page is associated with a context of “the big battle.” As such, the e-book context service 18 can provide the identified contexts and users predicted to have a contextual affinity with that context to the e-reader device user ahead of time. In addition, the e-book context service 18 and/or the e-reader devices 12-1 through 12-N can establish communication sessions that can be quickly activated when the e-reader device user's context changes to the predicted context.

As yet another option, a user leaves a history contrail of associated contexts whose strength fades over time. For example, an e-reader device user that is currently associated with the context of “end of big battle” is also associated with contexts of “the big battle” and “calm before the battle” but at incrementally lower levels. The history contrail of associated contexts allows for an e-reader device user to have an affinity with their past contexts and therefore is eligible for communication with other e-reader device users having contexts that are more distant than the e-reader device user's current context.

After context determination, the e-book context service 18 calculates a contextual affinity between the e-reader device user associated with the e-reader device user event(s) and other e-reader device users (step 1012). In essence, the e-book context service 18 performs the affinity calculation on the data within the edit history database 22 that is maintained by the e-book context service 18 with respect to ontologies, taxonomies, lists, and/or other such semantic data stores that contain topics and annotated relationships between topics. The affinity is based on a contextual distance that measures proximity based on the determined contexts and the e-reader device user event information. Contextual distance is a measure of how relevant an e-reader session is with respect to another e-reader session based on their respective contexts. As one option, the contextual distance may be based on the distance in an ontology or taxonomy such that contexts that are within a short distance on an ontological graph are determined to have a high affinity and vice versa. The average of all of a user's contexts compared to those of another can be used as the final affinity value.

As another option, the contextual distance may be based on context results that pertain to a reading location within a chapter of an e-book. For example, users of e-reader devices that are determined to have reading locations within a given chapter will have a greater contextual affinity than users of e-reader devices that are reading in chapters other than the given chapter.

As yet another option, a contextual affinity may be the result of evaluating multiple contexts such as ontology, location within an e-book chapter, and physical location such as determined by a GPS associated with a user's e-reader device. For example, users of e-reader devices having contexts within a short ontological distance, or have a reading location within a given chapter and also are within a predetermined range of each other as determined by GPS or other means, will be determined to have a high contextual affinity for each other. Note that the affinity may be weighed to favor certain contexts over other contexts. For example, a user of an e-reader device on the other side of the world may still have a high contextual affinity with other users of e-reader devices because ontology and reading location within a chapter may be more highly valued.

Once a contextual distance value between other e-reader device users and the e-reader device user of the e-reader device 12-1 has been calculated, relevant e-reader device users are identified and associated with the user of the e-reader device 12-1 based upon the calculated contextual distance value (step 1014).

Next, the e-book context service 18 returns a result that includes the identified e-reader device users and associated contexts to the e-reader device 12-1 (step 1016). Once the e-reader device 12-1 receives the identified e-reader device users and associated contexts, the e-reader device 12-1 automatically initiates connections with the identified relevant users (step 1018).

It is important to recognize that there are many ways in which the e-reader device 12-1 can communicate with the identified relevant e-reader device users. For example, if a user of an e-reader device 12-2 happens to be inside a WPAN along with the e-reader device 12-1, then the e-reader device 12-1 can send user context messages directly to the e-reader device 12-2 (step 1020). As shown in FIG. 2B, the e-reader device 12-2 can also send user context messages to the e-reader device 12-1 (step 1022). Alternately, the user of the e-reader device 12-2 may decide to create and/or join another communication session based on the user context messages received from the e-reader device 12-1 (step 1024).

On the other hand, if other identified relevant users such as a user of an e-reader device 12-3 and a user of an e-reader device 12-N are distantly located, the e-reader device 12-1 can send user context messages to the third-party communication service 28 (step 1026). The third-party communication service 28 may then create a communication session 30 that the e-reader device 12-3 and the e-reader device 12-N can join (step 1028). The communication session 30 is established by dynamically creating a voice or chat channel or by adding the user of the e-reader device 12-3 to a pre-existing chat room or voice channel associated with the identified contexts. Communication session information can be sent to the e-reader device 12-3 with the identified contexts or can be retrieved by querying the e-book context service 18. The communication session 30 may be hosted by the e-book context service 18, directly between the e-reader devices 12-1 and 12-3, the third-party communication service 28, or some combination thereof.

After the communication session 30 is created, the user context messages for the e-reader device 12-1 are sent from the third-party communication service 28 to the created communication session 30 (step 1030). In turn, the communication session 30 sends the user context messages for the user of the e-reader device 12-1 to the e-reader device 12-3 (step 1032).

At this point, the user of the e-reader device 12-3 can join the communication session 30 (step 1034). The e-reader device 12-3 may wait for an e-reader device user selection to create or join the communication session 30 that may include, but is not limited to, video, voice, text, and chat. The e-reader device user selection may be initiated by tapping a touch screen on the e-reader device 12-3, or by choosing e-book content displayed on the e-reader device touch screen by way of other touch screen gestures such as a flick, expand and pinch, etc. Moreover, an e-reader device user selection of an identified context, a specific user, or a predetermined set of users may also be useable to create or join the communication session 30. Alternatively, the e-reader device 12-3 may automatically create or join a communication session when a user is associated with a context. Also note that a communication session may be automatically destroyed or disconnected when a user is no longer associated with a context.

As another option, the user may be able to view current or predicted communication sessions for contexts associated with their e-book. A user can then drop into a communication session and their e-reader device adjusts to allow the user to navigate occurrences of content associated with the context.

Once the e-reader device 12-3 joins the communication session 30, the user context messages for the user of the e-reader device 12-3 may be sent to the created communication session 30 to be shared with other e-reader devices that may have joined the communication session 30 (step 1036).

Another communication option may be to send the context messages for the user of the e-reader device 12-1 from the communication session 30 to a message handling function 32 (step 1038). The message handling function 32 in turn sends the context messages for the user of the e-reader device 12-1 to the e-reader device 12-N (step 1040). At this point, the user of the e-reader device 12-N may decide to join the communication session 30 (step 1042). Once the communication session 30 is joined by the e-reader device 12-N, the user context messages of the e-reader device 12-N may be sent to the communication session 30 to be shared with other e-reader device users that join the communication session 30 (step 1044). The message handling function 32 may adapt messages based on context affinity. For example, the message handling function 32 may replace live audio with a message that commands an e-reader device to play a prerecorded message that is pre-stored on the e-reader device. In this way, bandwidth is preserved for messages associated with higher affinities.

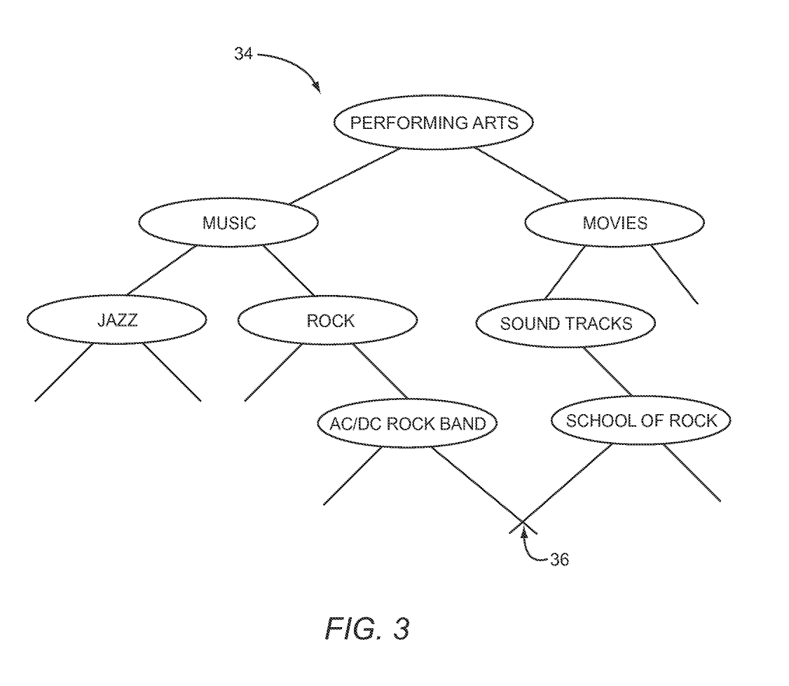

FIG. 3 depicts an ontological graph 34 in which users who have contexts that have overlaps 36 or are within a few hops within the ontological graph 34 are considered to have a high affinity. For example, a user editing a section on the rock band AC/DC has a medium level affinity with another user editing a section about the movie School of Rock because of the movie has many AC/DC dialog references and songs. A user's association with a set of contexts can change over time as their edits touch on various contexts. Regarding e-book reading location, e-reader device users who have e-book reading locations that are close together such as reading in the same chapter, reading on the same page, or reading only a predetermined number of pages ahead may result in a high affinity calculation. The identified e-reader device users can be further filtered using social network information, user profile matching, e-reader device location, consumption metrics, and the like. For example, in a military training environment wherein students are being taught how to operate a piece of military hardware, non-commissioned officers and commissioned officers would be filtered such that the non-commissioned officers would only be relevantly associated with other non-commissioned officers. In this way, a private having a question about the military hardware would be contextually associated with a sergeant as opposed to a general.

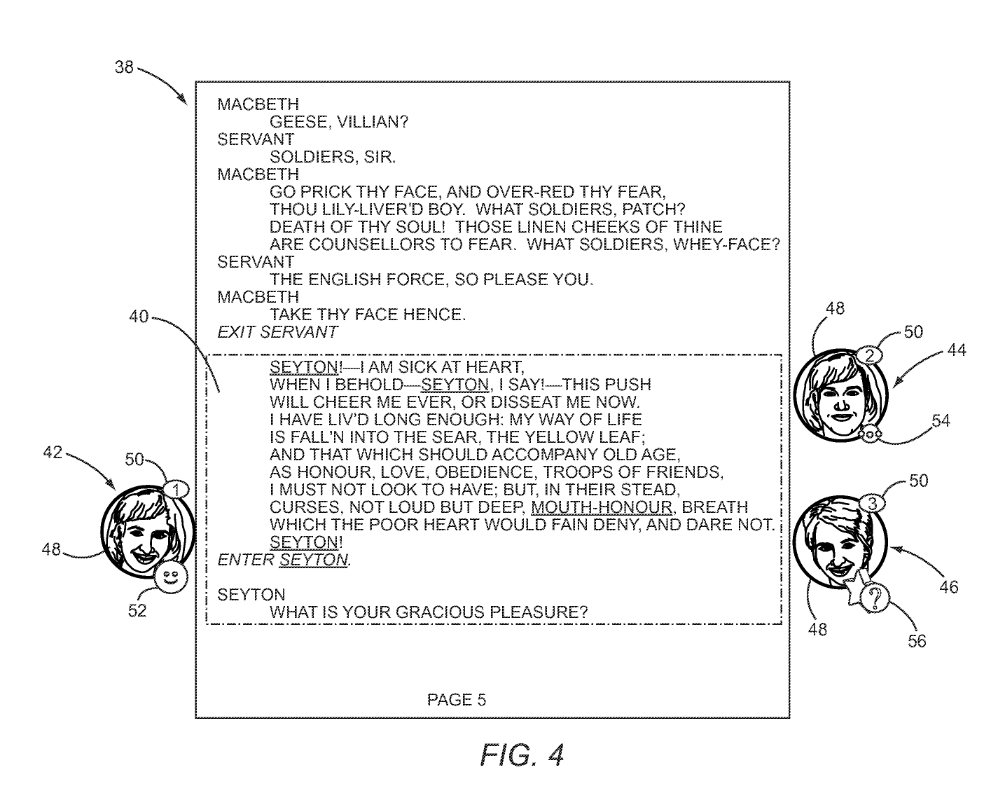

FIG. 4 shows an example of a user interface 38 that identifies the current context of an e-reader device user and identifies other e-reader device users with a high affinity with regard to the e-reader device user. However, the user of the e-reader device may also set a preference with the e-book context service 18 such that users with affinities above a given threshold may also be identified. The user of the e-reader device may want users with relatively low affinities to be identified in order to be more connected to a community of users. In FIG. 4, the rectangle with a dashed line depicts a current context 40 of the e-reader device user. The current context 40 may also be presented to the user by highlighting key terms in the content. Example key terms might be “Seyton” and “mouth-honour,” which are highlighted within the current context 40 by underlining. Other methods of highlighting, such as text bolding or font color change, etc., are also methods for highlighting key terms in the current context 40.

Groups of icons 42, 44, and 46 that are representative of the associated context may be placed in proximity to the current context 40 dotted line, in the margins of the e-content page, in the header or footer of the e-content page, and so forth. The identified e-reader device users with affinity to the current e-reader device user may be presented with an image 48 of each of the identified e-reader device users, a contextual affinity indicator 50 indicating a context distance, and a context icon 52 indicating a contextual change, along with a presence information icon 54 that indicates current communication availability, communication capability, and so forth. The presence information icon 54 for the icon 44 indicates that the user is currently offline. Another icon 56 indicates that the user represented by the icon 46 has a question for the other users represented by the images 48.

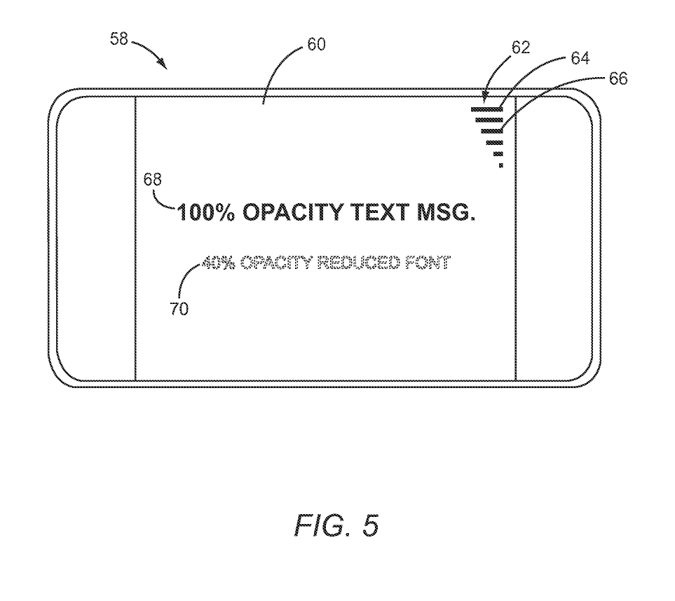

As depicted in FIG. 5, a user is provided a sense of a contextual community by adapting messages from other users based on contextual affinity. A body 58 of the e-reader device 12-N (FIG. 1) has a touch screen 60 on and through which messages associated with users with various contextual affinities are scalable for dramatic effect. In other words, messages between users having high contextual affinity are adapted to be more pronounced than messages associated with users with a low affinity. For example, the volume represented by volume indicator 62 of an incoming voice message from a user with a high affinity is increased to 110% of its original volume indicated by a volume bar 64, whereas an incoming message from a user with a medium affinity is reduced to 80% of its original volume level as indicated by a volume bar 66.

As another example, an incoming voice message from a user with a low affinity is replaced with a generic low volume level background talking noise to indicate that someone is talking. As yet another example, a text message from a user that is editing the same page is presented in the original message font with 100% opacity represented by an example text 68, whereas a text message from a user that is editing content several chapters ahead is changed to a reduced font with 40% opacity as represented by an example text 70. The less pronounced text message is recognized by the user as being less relevant due to the other user being more distant contextually.

In another aspect, the presentation of incoming notifications of other user's contexts and events are adapted based on contextual affinity. The e-reader device 12-N may adjust the volume level for sound effects associated with notifications. For example, the volume level of a page turning sound is higher for users in close proximity than for users further away. A specific example would be an event/notification associated with a user whose e-book content location is one page away, which results in a louder sound effect than a sound effect for another user who is hundreds of pages away from the same e-book content location. Another specific example would be wherein one user is reading about General George Washington and a second user is reading about the Revolutionary War and a third user is reading about the Vietnam War. In this case, a first event for the second user would be louder than a second event for a third user.

As another option, the e-reader device 12-N presents an overlay notification with an opacity level and size based on contextual affinity. For example, an edit notification results in the e-reader device 12-N temporarily overlaying icons representative of the context of the edited section or temporarily highlights key terms associated with the context. Icons for topics related to the current user's context are larger or otherwise more prominent than the icons for topics unrelated to the current user's context.

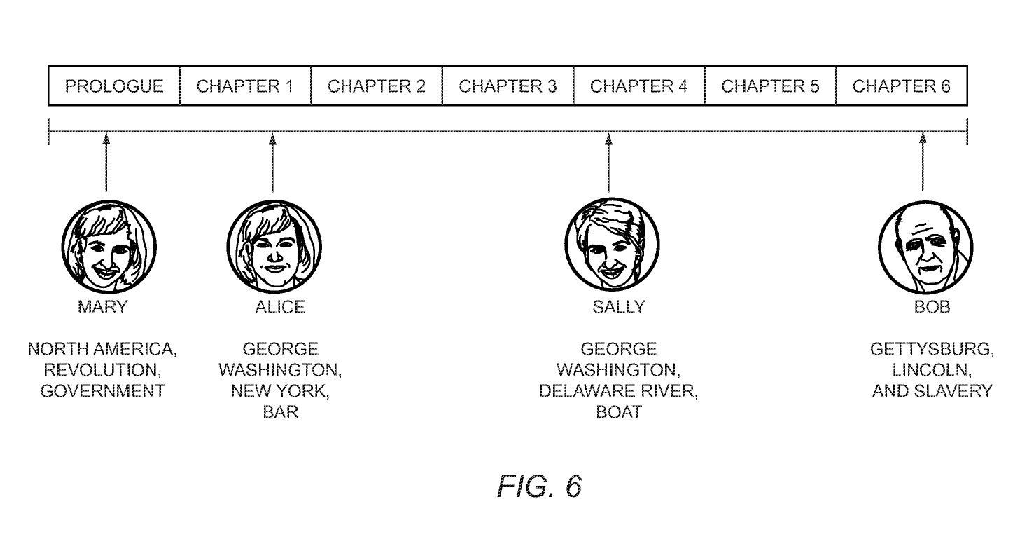

In an operative example associated with FIG. 6, Mary, Alice, Bob, and Sally are collaboratively editing an American history book together using their e-reader devices. Their e-reader devices send contextual events to the e-book context service 18 (FIG. 1), which may be residing in a network cloud service as they read and edit the book. The e-book context service 18 processes the events to create contextually relevant communication groups and to determine which events and messages to send to which users.

In this example, Mary is editing the prologue to the book. Her e-reader device is provisioned with a contextual analysis function that processes her modifications to the book. The contextual analysis function determines Mary's context, determines that the context is significant to report to the e-book context service 18, and sends a contextual event to the e-book context service 18. The contextual event includes information indicating that Mary is editing a section on page seven with the topics of North America, revolution, and government.

Similarly, Alice is editing chapter one in the book several pages ahead of where Mary is editing. Alice's e-reader device performs the same type of contextual analysis functions and sends a contextual event to the e-book context service 18 indicating that Alice is editing a section on page thirteen about George Washington, New York, and a bar.

Sally is also editing a section in the same e-book. However, Sally's edits are with regard to chapter five and pertain to George Washington, the Delaware River, and a boat. Sally's e-reader device reports this information to the e-book context service 18.

In this example, Bob's e-reader device does not have the embedded contextual analysis function 14-N (FIG. 1), so his e-reader device collects and then sends information associated with Bob's e-reader device user events to the e-book context service 18. Typically, the information associated with Bob's e-reader device user events includes his current e-book's ISBN and title along with other data such as current page number, etc. In this example case, the associated information sent to the e-book context service 18 indicates that Bob is editing the content on page one hundred and twenty-three. Once the e-book context service 18 receives the information associated with Bob's e-reader device user event, the e-book context service 18 performs a contextual analysis via the multi-client context analysis function 20 (FIG. 1) and determines the topics of Gettysburg, Lincoln, and slavery.

As the e-book context service 18 receives contextual information from Mary, Alice, Sally, and determines the context of Bob's e-reader device user event, the e-book context service 18 evaluates the contextual affinity between Mary, Alice, Sally, and Bob. In this case the e-book context service 18 groups Mary, Alice, and Sally together because they have a small contextual distance between them based on a combination of page location and edit contexts. In particular, Mary, Alice, and Sally share contexts pertaining to George Washington and the revolutionary war. Bob is not placed in the same group because Bob's context is determined by the multi-client contextual analysis function 20 to pertain to contexts that are unrelated to the context shared by Mary, Alice, and Sally. In other words, Bob is editing a section of the e-book that does not pertain to George Washington and the revolutionary war.

As the e-book editing process continues, Mary finalizes her edits and saves the changes. Mary's e-reader device sends contextual events to the e-book context service 18 indicating the type of edits, the content of the edits, and the topics the edits were associated with, in this case the revolutionary war and the Potomac River. The e-book context service 18 evaluates Mary's contextual events and determines they are relevant to Alice due to book reading location proximity, which in this case determines that the reading locations of Mary and Alice are only two pages apart. Moreover, the topic revolutionary war is related to George Washington, which indicates relevance to Sally due to the related topics of the Potomac River and Delaware River. Even though Bob is much further ahead in the e-book and working on different topics, Bob is also considered a relevant e-reader device user because Bob's edit history includes recent edits to George Washington related content, which is related to the revolutionary war and the Potomac River. After identifying the contextual relevance between Mary, Alice, Sally, and Bob, the e-book context service 18 forwards the relevant information associated with the e-reader device user events to the respective e-reader devices being used by Mary, Alice, Sally, and Bob.

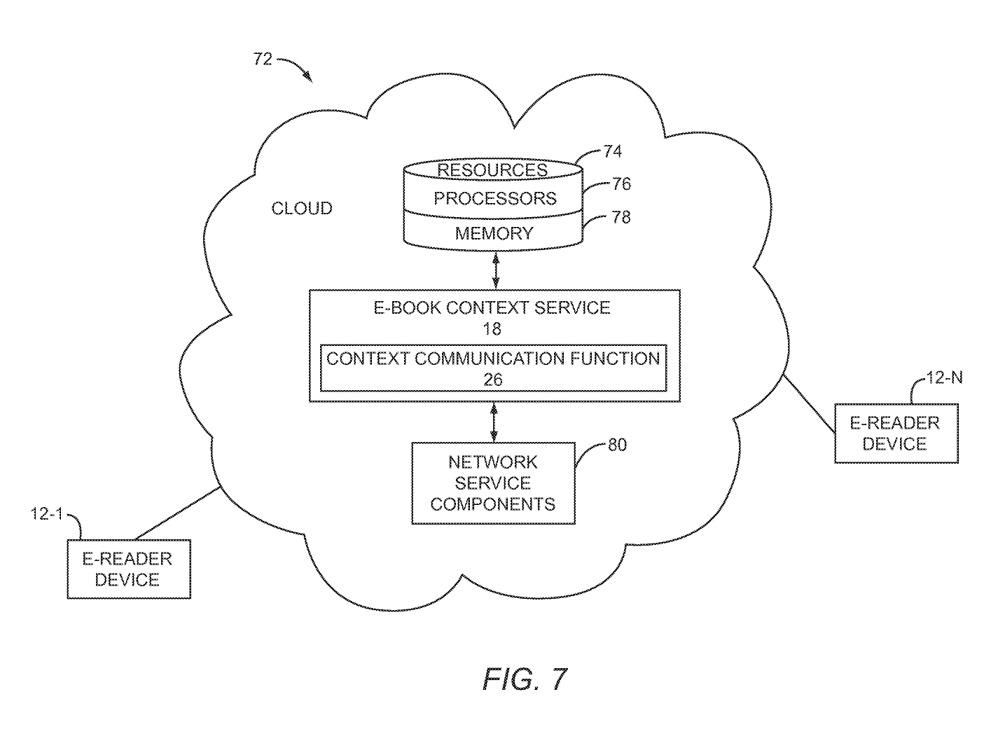

FIG. 7 depicts the e-book context service 18 being implemented as a cloud service 72. The e-book context service 18 is communicatively coupled to resources 74, which include processors 76 and memory 78. Network service components 80 are communicatively coupled to the context communication function 26 of the e-book context service 18. The network service components 80 provide the necessary hardware and software for communicating with cloud connectable e-reader devices 12-1 through 12-N.

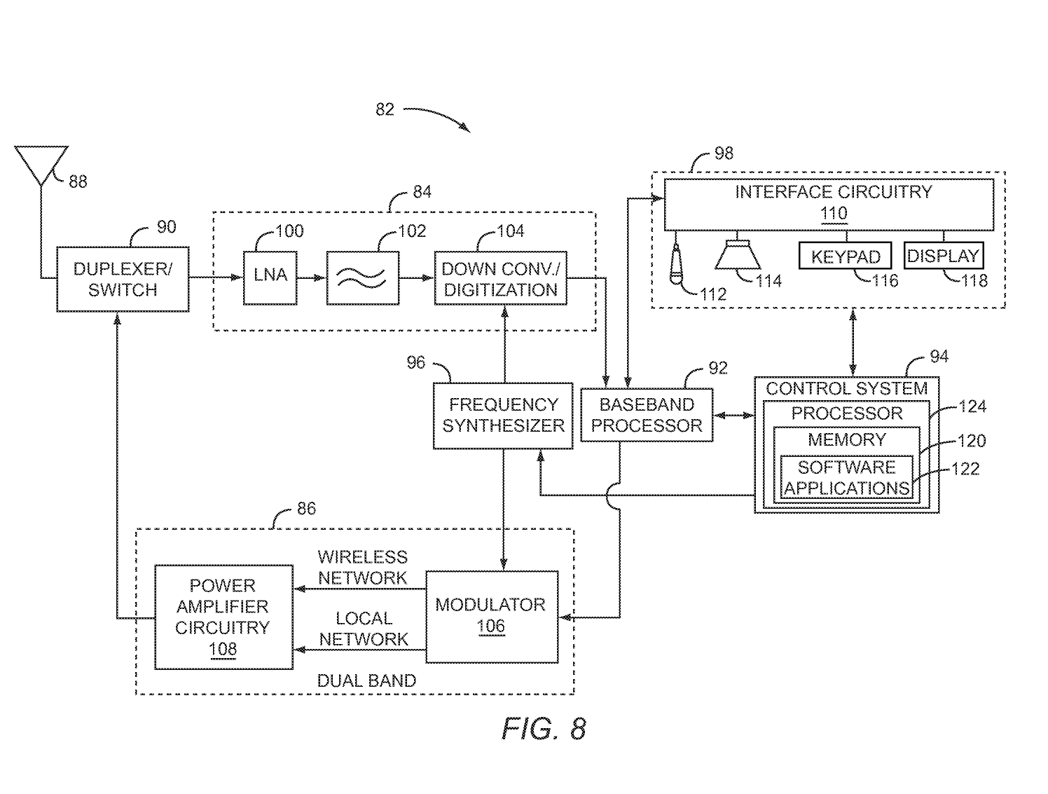

FIG. 8 depicts the basic architecture of a wireless smart phone 82 that is useable as the e-reader devices 12-1 through 12-N (FIG. 1). The wireless smart phone 82 may include a receiver front end 84, a radio frequency transmitter section 86, an antenna 88, a duplexer or switch 90, a baseband processor 92, a control system 94, a frequency synthesizer 96, and a user interface 98. The receiver front end 84 receives information bearing radio frequency signals from one or more remote transmitters provided by a base station (not shown). A low noise amplifier 100 amplifies the signal. A filter circuit 102 minimizes broadband interference in the received signal, while downconversion and digitization circuitry 104 downconverts the filtered, received signal to an intermediate or baseband frequency signal, which is then digitized into one or more digital streams. The receiver front end 84 typically uses one or more mixing frequencies generated by the frequency synthesizer 96. The baseband processor 92 processes the digitized received signal to extract the information or data bits conveyed in the received signal. This processing typically comprises demodulation, decoding, and error correction operations. As such, the baseband processor 92 is generally implemented in one or more digital signal processors (DSPs).

On the transmit side, the baseband processor 92 receives digitized data, which may represent voice, data, or control information, from the control system 94, which it encodes for transmission. The encoded data is output to the radio frequency transmitter section 86, where it is used by a modulator 106 to modulate a carrier signal that is at a desired transmit frequency. Power amplifier circuitry 108 amplifies the modulated carrier signal to a level appropriate for transmission, and delivers the amplified and modulated carrier signal to the antenna 88 through the duplexer or switch 90.

A user may interact with the wireless smart phone 82 via the user interface 98, which may include interface circuitry 110 associated with a microphone 112, a speaker 114, a physical or virtual keypad 116, and a touch screen display 118. The interface circuitry 110 typically includes analog-to-digital converters, digital-to-analog converters, amplifiers, and the like. Additionally, the interface circuitry 110 may include a voice encoder/decoder, in which case the interface circuitry 110 may communicate directly with the baseband processor 92.

The microphone 112 will typically convert audio input, such as the user's voice, into an electrical signal, which is then digitized and passed directly or indirectly to the baseband processor 92. Audio information encoded in the received signal is recovered by the baseband processor 92 and converted by the interface circuitry 110 into an analog signal suitable for driving the speaker 114. The keypad 116 and the touch screen display 118 enable the user to interact with the wireless smart phone 82, input numbers to be dialed, address book information, or the like, as well as monitor call progress information.

The control system 94 includes a memory 120 for storing data and software applications 122, and a processor 124 for running the operating system and executing the software applications 122. When the wireless smart phone 82 is used as the e-reader devices 12-1 through 12-N for reading and/or editing e-books, the memory 120 will be loaded with an e-reader software application along with e-book content. Moreover, provided that the memory 120 is large enough and the processor 124 is powerful enough, an application that provides the function of the message handling function 32 (FIG. 2B) could be stored in the memory of the wireless smart phone 82 and executed by the processor of the wireless smart phone 82.

Those skilled in the art will recognize improvements and modifications to the preferred embodiments of the present invention. For example, the e-book context service 18 (FIG. 1) may be adapted to be implemented as software loaded on an e-reader device such as the e-reader device 12-1. Moreover, the e-book context server 18 may be implemented as software components distributed among several e-reader devices in a peer-to-peer (P2P) network or distributed computer environment. All such improvements and modifications are considered within the scope of the concepts disclosed herein and the claims that follow.

What is claimed is:

1. A computerized method for e-book contextual communication, the computerized method comprising:
receiving information that is associated with an e-reader device user event;
identifying e-reader device users, which are relevant to the e-reader device user event based upon a context included in the information or determined from the information, as relevant e-reader device users; and
effecting communication with the relevant e-reader device users.

2. The computerized method of claim 1, wherein the information comprises at least one of a group consisting of: an e-book title, an International Standard Book Number (ISBN), a current e-book reading or editing location, an e-reader device location, e-reader device user data, e-reader device data, a content change type, and a modified content.

3. The computerized method of claim 2, wherein effecting communication between the relevant e-reader device users includes sending a message to one or more of the relevant e-reader device users based upon a contextual affinity between a contextual analysis of the information associated with the e-reader device user event and the relevant e-reader device users.

4. The computerized method of claim 3, wherein the message being sent to each relevant e-reader device user is adapted for scalable dramatic effect in relation to the contextual affinity between the contextual analysis of the information associated with the e-reader device user event and the relevant e-reader device users.

5. The computerized method of claim 4, wherein the scalable dramatic effect comprises at least one of a group consisting of: a volume level of a voice message, an opacity of a font of a text message, a volume level of a page turn sound effect, a dimension scale of a message icon, and a volume setting for a prerecorded sound track present on a messaged e-reader device.

6. The computerized method of claim 1, wherein the information is filtered using filter rules to exclude information associated with contextually irrelevant e-reader device user events.

7. The computerized method of claim 6, wherein identifying e-reader device users that are relevant to an e-reader user device event includes a step of analyzing the information to determine the context of the e-reader device user event.

8. The computerized method of claim 7, wherein the step of analyzing the information uses context rules to determine one or more contexts for the e-reader device user event.

9. The computerized method of claim 8, wherein the context rules are provided by at least one of a group consisting of: authors, publishers, e-book context service providers, e-book reading communities, and e-book reader device users and combinations thereof.

10. The computerized method of claim 9, wherein a contextual distance value is determined for distances between contexts of e-reader device user events.

11. The computerized method of claim 10, further including an ontology of contexts that is useable to determine the contextual distance value.

12. The computerized method of claim 10, wherein the contextual distance value is useable to identify users that are relevant to an e-reader user event.

13. A computerized method for e-book contextual communication, the computerized method comprising:
capturing an e-reader device user event;
obtaining identifications of e-reader device users who are relevant to the e-reader device user event based upon a context of the e-reader device user event; and
effecting communication with the relevant e-reader device users.

14. The computerized method of claim 13, wherein a captured e-reader device user event is filtered using filter rules to exclude contextually irrelevant e-reader device user events.

15. The computerized method of claim 13, wherein a captured e-reader device user event comprises at least one of a group consisting of: a page turn, a content edit, and a content selection.

16. The computerized method of claim 13, wherein capturing an e-reader device user event further includes a step of analyzing a captured e-reader device user event via context rules to determine one or more contexts for the e-reader device user event.

17. The computerized method of claim 13, wherein a context rule processes a captured e-reader device user event to determine a relative edit location within an e-book content.

18. The computerized method of claim 13, wherein a context rule processes an e-reader device event history to determine an editing behavior of an e-reader device user.

19. The computerized method of claim 13, wherein capturing an e-reader device user event further includes a step of semantically analyzing a captured e-reader device user event to determine one or more contexts for the e-reader device user event.

20. The computerized method of claim 13, wherein effecting communication with the relevant e-reader device users includes sending a message to each relevant e-reader device user based upon a contextual affinity between a contextual analysis of the e-reader device user event and identified relevant e-reader device users.

21. The computerized method of claim 20, wherein the message being sent to each relevant e-reader device user is adapted for a scalable dramatic effect in relation to the contextual affinity between the contextual analysis of information associated with the e-reader device user event and the relevant e-reader device users.

22. The computerized method of claim 21, wherein the scalable dramatic effect comprises at least one of a group consisting of: a volume level of a voice message, an opacity of a font of a text message, a volume level of a page turn sound effect, a dimension scale of a message icon, and a volume setting for a prerecorded sound track present on a messaged e-reader device.

23. The computerized method of claim 13, further including receiving a contextual message from another e-reader device.

24. The computerized method of claim 23, wherein the contextual message being received from another e-reader device is adapted for a scalable dramatic effect in relation to a contextual affinity between a message receiving e-reader device user and the another e-reader device.

25. A system for e-book contextual communication, the system comprising:
an e-reader device having a memory for storing e-book content and applications, a processor for executing the applications, an embedded communication function and an electronic touch screen for displaying a displayable e-book content and for receiving a user touch gesture for capturing an e-reader device user event associated with a context of the displayable e-book content; and
an e-book context service application stored in the memory of the e-reader device and being executable by the processor of the e-reader device to receive information that is associated with the e-reader device user event, to identify e-reader device users, which are relevant to an e-reader device user event based upon a context determined from the information, as relevant e-reader device users, and to effect communication with the relevant e-reader device users by way of the embedded communication function.

26. The system of claim 25, wherein a captured e-reader device user event comprises at least one of a group consisting of: a page turn, a content selection, and a content edit.
